(19) United States
(12) Patent Application Publication
(10) Pub. No.: US 2022/0242433 A1
(43) Pub. Date: Aug. 4, 2022

(54) SALIENCY-BASED PRESENTATION OF OBJECTS IN AN IMAGE

(71) Applicant: GM GLOBAL TECHNOLOGY OPERATIONS LLC, Detroit, MI (US)

(72) Inventors: Ron M. Hecht, Raanana (IL); Yael Shmueli Friedland, Tel Aviv (IL); Ariel Telpaz, Givat Haim Meuhad (IL); Dan Levi, Kyriat Ono (IL)

(21) Appl. No.: 17/165,162

(22) Filed: Feb. 2, 2021

(51) Int. Cl. B60W 50/14; G06K 9/00; G06K 9/32; G06K 9/62

(52) U.S. Cl. CPC B60W 50/14; G06K 9/00805; B60W 2420/42; G06K 9/6232; B60W 2050/146; G06K 9/3233

(57) ABSTRACT

A system for notifying a user of a vehicle includes a receiving module configured to receive detection data related to an environment around the vehicle, the detection data including an image of at least a portion of the environment. The system also includes an analysis module configured to detect an object in the image and determine a level of salience of the object to the user, an image enhancement module configured to apply one or more saliency features to a region of the image corresponding to the object, the one or more saliency features including an adjustment to an image attribute in the region, the adjustment based on the level of salience and configured to draw attention of the user to the region without occluding the region, and a display module configured to present a display including the image and the one or more saliency features to the user.

### INTRODUCTION

The subject disclosure relates to the art of image analysis and presentation of visual information. More particularly, the subject disclosure relates to a system and method for controlling visual attributes of one or more regions of a display.

Cameras and/or other imaging devices and sensors are increasingly included in vehicles to facilitate vehicle operation, inform users and control automated behaviors of vehicles and other systems. Increasingly digital displays are incorporated into vehicles. For example, digital screens can be included in consoles, in rear-view and side mirrors, and in heads up displays (HUDs). Such displays can be used to alert or notify users of objects and features in the surrounding environment.

### SUMMARY

In one exemplary embodiment, a system for notifying a user of a vehicle includes a receiving module configured to receive detection data from one or more sensors, the detection data related to an environment around the vehicle, the detection data including an image of at least a portion of the environment. The system also includes an analysis module configured to detect an object in the image and determine a level of salience of the detected object to the user, an image enhancement module configured to apply one or more saliency features to a region of the image corresponding to the detected object, the one or more saliency features including an adjustment to an image attribute in the region, the adjustment based on the level of salience and configured to draw attention of the user to the region without occluding the region, and a display module configured to present a display including the image and the one or more saliency features to the user.

In addition to one or more of the features described herein, the image is an optical image taken by a camera, and the display is a digital display in the vehicle.

In addition to one or more of the features described herein, the image attribute is selected from at least one of color, brightness, focus level and contrast.

In addition to one or more of the features described herein, the level of salience is based on at least one of: an uncertainty in detection of the detected object, an attentiveness of the user to the detected object, a classification of the detected object, and a risk value associated with the detected object.

In addition to one or more of the features described herein, an intensity of the adjustment is selected based on the level of salience.

In addition to one or more of the features described herein, the one or more saliency features includes a combination of a plurality of saliency features.

In addition to one or more of the features described herein, the intensity corresponds to a selected value of the attribute relative to a value of the attribute in the image outside of the region.

In addition to one or more of the features described herein, at least one of the intensity of the adjustment and a number of saliency features applied to the region is gradually changed in the display as the level of salience changes.

In one exemplary embodiment, a method of notifying a user of a vehicle includes receiving detection data from one or more sensors, the detection data related to an environment around the vehicle, the detection data including an image of at least a portion of the environment, and detecting, by an analysis module, an object in the image and determining a level of salience of the detected object to the user. The method also includes applying, by an image enhancement module, one or more saliency features to a region of the image corresponding to the detected object, the one or more saliency features including an adjustment to an image attribute in the region, the adjustment based on the level of salience and configured to draw attention of the user to the region without occluding the region, and presenting a display including the image and the one or more saliency features to the user.

In addition to one or more of the features described herein, the image is an optical image taken by a camera, and the display is a digital display in the vehicle.

In addition to one or more of the features described herein, the image attribute is selected from at least one of color, brightness, focus level and contrast.

In addition to one or more of the features described herein, the level of salience is based on at least one of: an uncertainty in detection of the detected object, an attentiveness of the user to the detected object, a classification of the detected object, and a risk value associated with the detected object.

In addition to one or more of the features described herein, an intensity of the adjustment is selected based on the level of salience.

In addition to one or more of the features described herein, the one or more saliency features includes a combination of a plurality of saliency features.

In addition to one or more of the features described herein, the intensity corresponds to a selected value of the attribute relative to a value of the attribute in the image outside of the region.

In addition to one or more of the features described herein, at least one of the intensity of the adjustment and a number of saliency features applied to the region is gradually changed in the display as the level of salience changes.

In one exemplary embodiment, a vehicle system includes a memory having computer readable instructions, and a processing device for executing the computer readable instructions, the computer readable instructions controlling the processing device to perform receiving detection data from one or more sensors, the detection data related to an environment around the vehicle, the detection data including an image of at least a portion of the environment, and detecting, by an analysis module, an object in the image and determining a level of salience of the detected object to the user. The instructions also control the processing device to perform applying, by an image enhancement module, one or more saliency features to a region of the image corresponding to the detected object, the one or more saliency features including an adjustment to an image attribute in the region, the adjustment based on the level of salience and configured to draw attention of the user to the region without occluding the region, and presenting a display including the image and the one or more saliency features to the user.

In addition to one or more of the features described herein, the level of salience is based on at least one of: an uncertainty in detection of the detected object, an attentiveness of the user to the detected object, a classification of the detected object, and a risk value associated with the detected object.

In addition to one or more of the features described herein, an intensity of the adjustment is selected based on the level of salience, and the intensity corresponds to a selected value of the attribute relative to a value of the attribute in the image outside of the region.

In addition to one or more of the features described herein, the one or more saliency features includes a combination of a plurality of saliency features.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including aspects of a notification and display system, in accordance with an exemplary embodiment;

FIG. 2 depicts a computer system configured to perform aspects of detection and notification, in accordance with an exemplary embodiment;

FIG. 3 is a flow diagram illustrating aspects of a method of notifying a user and presenting saliency-based displays;

FIG. 4 depicts an example of an image acquired from a monitoring system of a vehicle, the image displayed according to the method of FIG. 3, in accordance with an exemplary embodiment;

FIG. 5 depicts an example of an image acquired from a monitoring system of a vehicle and displayed according to a prior art technique;

FIG. 6 is a flow diagram illustrating aspects of a method of generating or selecting saliency features for application to an image;

FIG. 7 depicts an example of a display presented according to the method of FIG. 3, including one or more saliency features corresponding to a detected object in a low risk condition;

FIG. 8 depicts the display of FIG. 7, including one or more saliency features corresponding to the detected object in a medium risk condition; and

FIG. 9 depicts the display of FIGS. 7 and 8, including one or more saliency features corresponding to the detected object in a high risk condition.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods and systems are provided for notifying a user (e.g., driver or passenger of a vehicle) and displaying features of an environment around a vehicle or other system. An embodiment of a notification and display system is configured to acquire an image (or other visual representation) of the environment, and based on detecting an object (also referred to as a target), apply a saliency feature or set of saliency features to the image. A “saliency feature” is a subtle manipulation or adjustment of one or more image attributes (e.g., color, brightness) in a region of the image, which is used to inject information and augment or highlight a detected object in a subtle manner. The manipulation or adjustment is “subtle,” in that the manipulation does not add any opaque elements or other elements (e.g., opaque lines or shapes, additional graphics, virtual objects) that would occlude any part of the image, impose a visual attentional capture (i.e., draw a user's attention to a region such that the user is inattentive to other targets or regions, or is inattentive to other salient or important regions of an image), reduce the amount of information conveyed by the image, or interfere with image analysis. Examples of saliency features include color adjustment to a region of an image, brightness adjustment to a region, and semi-transparent lines, contours and objects that may be overlaid on an image.

A saliency feature is applied to an image to emphasize a detected object or objects in an image, thereby drawing the attention of a user (e.g., driver and/or passenger) to a specific area or location in the image and conveying some amount of importance or salience to the user. In an embodiment, a saliency feature corresponds to an adjustment of an image attribute, such as color, hue, shading, brightness, contrast, focus and others. A saliency feature may be applied to an image via an adjustment of a single image attribute, or via adjustment of a combination of image attributes. It is to be understood that a “saliency feature” or “set of saliency features” may include adjustment of a single image attribute or multiple attributes.

In an embodiment, a saliency feature is applied to a region of a detected object based on a level of salience, or salience level, to the user. The level of salience corresponds to the urgency or importance of the object (i.e., how relevant the object is to operation of the vehicle and/or safety). The salience level may correspond to a level of risk associated with the object, an urgency by which the user or vehicle should react, a confidence level or uncertainty associated with a detection, and others.

A saliency feature or combination of features may be varied in an image, so that the salience level associated with an object can be varied. The salience level can be adjusted or selected based on various conditions or factors. For example, the salience level may be based on the confidence level of a detection (e.g., detection score), target classification and/or risk or threat level. In addition, the salience level can be adjusted dynamically as a detected object moves or changes, or as risk level changes.

Generally, although embodiments are described herein in the context of an optical image (i.e., an image generated by an optical camera), it is to be understood that the embodiments are applicable to any form of visual representation (e.g., images generated by ultrasound, images based on radar information, thermal images, graphical representation, video, animation, etc.). For example, a saliency feature or combination of saliency features, such as color and brightness, blinking or alternating adjustment of an image attribute (e.g., make a target or region alternate between high and low brightness, or alternate between colors) can be applied to a map display or other graphic.

Embodiments described herein provide a number of advantages. For example, the embodiments provide an effective means of communicating importance or conveying information to a user without overly distracting the user or introducing high cognitive cost. In addition, the embodiments are useful in situations where detection of an object has a level of uncertainty. For example, in some situations, targets can be detected incorrectly (e.g., false alarm (type I error) or misdetection (type II error)), thus there may be a desire to present object information without the need to make an explicit classification, or make a binary or dichotomic decision as to whether to emphasize an object. Furthermore, the display system can gradually adjust saliency features to convey changes in importance or risk (e.g., an object is approaching the vehicle) without excessive cognitive cost, attentional capture or clutter to the image.

Embodiments are described below in the context of vehicle operation. The embodiments are not so limited, and may be used in any of various contexts where situational awareness of a user is a factor. Thus, embodiments described herein are understood to be applicable to any of various contexts (e.g., operation of power tools, aircraft, construction activities, factory machines (e.g., robots) and others).

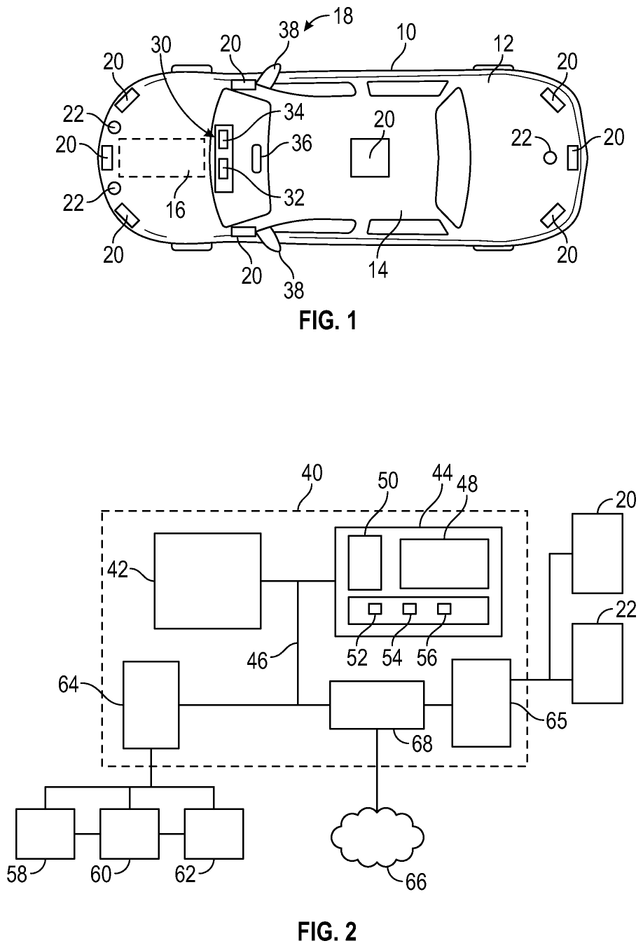

FIG. 1 shows an embodiment of a motor vehicle 10, which includes a vehicle body 12 defining, at least in part, an occupant compartment 14. The vehicle body 12 also supports various vehicle subsystems including an engine system 16 (e.g., combustion, electrical, and other), and other subsystems to support functions of the engine system 16 and other vehicle components, such as a braking subsystem, a steering subsystem, and others.

The vehicle also includes a monitoring system 18, aspects of which may be incorporated in or connected to the vehicle 10. The system 18 in this embodiment includes one or more optical cameras 20 configured to take images, which may be still images and/or video images. Additional devices or sensors may be included in the system 18, such as one or more radar assemblies 22 included in the vehicle 10. The system 18 is not so limited and may include other types of sensors, such as infrared cameras.

The vehicle 10 and the system 18 also include an on-board computer system 30 that includes one or more processing devices 32 and a user interface 34. The user interface 34 may include a touchscreen, a speech recognition system and/or various buttons for allowing a user to interact with features of the vehicle. The user interface 34 may be configured to interact with the user via visual communications (e.g., text and/or graphical displays), tactile communications or alerts (e.g., vibration), and/or audible communications. The on-board computer system 30 may also include or communicate with devices for monitoring the user, such as interior cameras and image analysis components. Such devices may be incorporated into a driver monitoring system (DMS).

In addition to the user interface 34, the vehicle 10 may include other types of displays and/or other devices that can interact with and/or impart information to a user. For example, in addition to, or alternatively, the vehicle 10 may include a display screen (e.g., a full display mirror or FDM) incorporated into a rearview mirror 36 and/or one or more side mirrors 38. In one embodiment, the vehicle 10 includes one or more heads up displays (HUDs). Other devices that may be incorporated include indicator lights, haptic devices, interior lights, auditory communication devices, and others.

The various displays, haptic devices, lights, and auditory devices are configured to be used in various combinations to present information to a user (e.g., a driver, operator or passenger) in various forms. Examples of such forms include textual, graphical, video, audio, haptic and/or other forms by which information is communicated to the user. For example, in addition to presenting saliency-based images to a user (e.g., via digital display in a vehicle such as a cluster display or an augmented reality display), other forms of communication such as haptics (e.g., vibration), audible alerts can be used to assist in alerting the user and/or drawing the user's attention.

FIG. 2 illustrates aspects of an embodiment of a computer system 40 that is in communication with, or is part of, the monitoring system 18, and that can perform various aspects of embodiments described herein. The computer system 40 includes at least one processing device 42, which generally includes one or more processors for performing aspects of image acquisition and analysis methods described herein. The processing device 42 can be integrated into the vehicle 10, for example, as the on-board processing device 32, or can be a processing device (off-board) separate from the vehicle 10, such as a server, a personal computer or a mobile device (e.g., a smartphone or tablet). The computer system 40 or components thereof may be part of a notification and display system as discussed herein.

Components of the computer system 40 include the processing device 42 (such as one or more processors or processing units), a system memory 44, and a bus 46 that couples various system components including the system memory 44 to the processing device 42. The system memory 44 may include a variety of computer system readable media. Such media can be any available media that is accessible by the processing device 42, and includes both volatile and non-volatile media, and removable and non-removable media.

For example, the system memory 44 includes a non-volatile memory 48 such as a hard drive, and may also include a volatile memory 50, such as random access memory (RAM) and/or cache memory. The computer system 40 can further include other removable/non-removable, volatile/non-volatile computer system storage media.

The system memory 44 can include at least one program product having a set (e.g., at least one) of program modules that are configured to carry out functions of the embodiments described herein. For example, the system memory 44 stores various program modules that generally carry out the functions and/or methodologies of embodiments described herein. A receiving module 52 may be included to perform functions related to acquiring and processing received images and detection data from sensors, and an image analysis module 54 may be included for image analysis, object detection and object classification. An image enhancement module 56 may also be provided for applying saliency features to images, to generate saliency-based images. Other modules may include a display module for displaying saliency-enhanced images. The system 40 is not so limited, as other modules may be included. The system memory 44 may also store various data structures, such as data files or other structures that store data related to imaging and image processing. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 42 can also communicate with one or more external devices 58 such as a keyboard, a pointing device, and/or any devices (e.g., network card, modem, etc.) that enable the processing device 42 to communicate with one or more other computing devices. In addition, the processing device 32 can communicate with one or more devices such as the cameras 20 and the radar assemblies 22 used for image analysis. The processing device 32 can communicate with one or more display devices 60 (e.g., an onboard touchscreen, cluster, center stack, HUD, mirror displays (FDM) and others), and vehicle control devices or systems 62 (e.g., for partially autonomous (e.g., driver assist) and/or fully autonomous vehicle control). Communication with various devices can occur via Input/Output (I/O) interfaces 64 and 65.

The processing device 32 may also communicate with one or more networks 66 such as a local area network (LAN), a general wide area network (WAN), and/or a public network (e.g., the Internet) via a network adapter 68. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

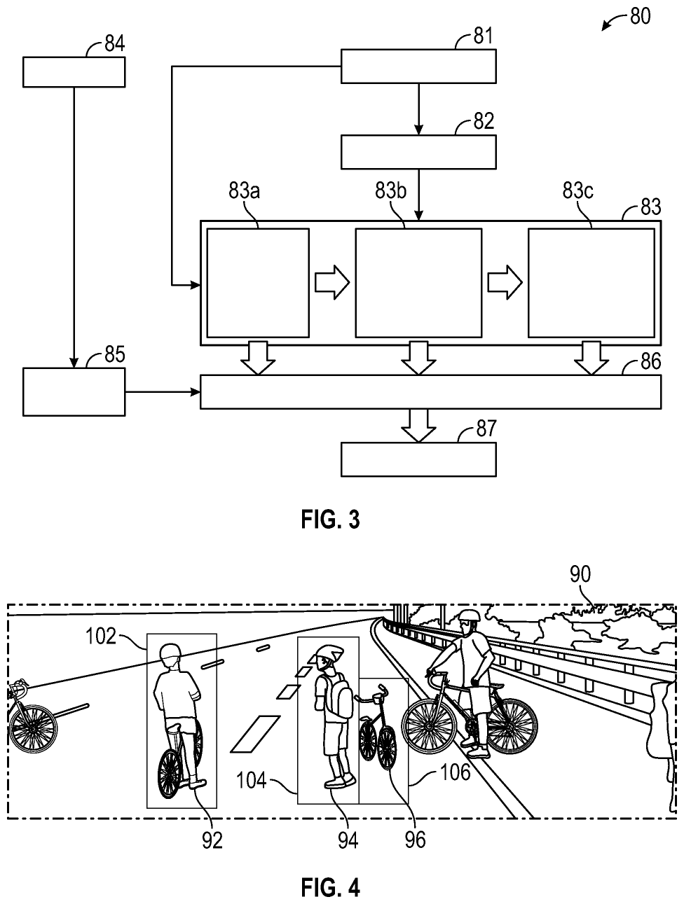

FIG. 3 depicts an embodiment of a method 80 of monitoring a vehicle environment, detecting objects and notifying a user, including presenting saliency-based images to a user. Aspects of the vehicle 10, the computer system 40, or other processing device or system, may be utilized for performing aspects of the method 80. The method 80 is discussed in conjunction with blocks 81-87. The method 80 is not limited to the number or order of steps therein, as some steps represented by blocks 81-87 may be performed in a different order than that described below, or fewer than all of the steps may be performed.

The methods discussed herein are described in conjunction with the vehicle 10, but are not so limited and can be used in conjunction with various vehicles (e.g., cars, trucks, aircraft) and/or other systems (e.g., construction equipment, manufacturing systems, robotics, etc.).

At block 81, a processing device (e.g., the on-board processor 32 of FIG. 1) monitors vehicle surroundings or the vehicle environment using one or more of various monitoring devices during operation of a vehicle. For example, the processing device can monitor the environment around the vehicle using optical cameras, lidar, radar, ultrasound and/or any other imaging system.

At block 82, the processing device detects whether there are any objects in the environment, or acquires or receives data related to detected objects (e.g., from another processing device or system), and determines whether any detected objects are relevant or potentially relevant to vehicle operation (e.g., manual and/or automated operation). A detected object may be referred to herein as a “target.” It is noted that detection of an object may be accompanied by some level of uncertainty, and accordingly may be considered tentative or putative, in that the system may not have enough information at a given time to confirm that the object is indeed relevant.

A detected object may be considered relevant if the detected object is at a location and/or moving such that the object can potentially affect operation of the vehicle (e.g., may require that the vehicle perform a maneuver to avoid the object) or present a safety risk. For example, a detected object is considered relevant if the detected object is in or intersects a predicted path of the vehicle 10, is within a threshold distance from the vehicle and/or predicted path, is in a vulnerable location (e.g., on or crossing a road), or otherwise is determined or predicted to constitute a threat or risk.

For example, the processing device performs image analysis of camera images, potentially in conjunction with radar detection data and/or other sensor data. Detection data indicative of identified targets are input to the image analysis module 54, which generates a detection map or other data structure that indicates one or more regions of the image in which a detected target or targets are represented.

For example, the processing device identifies the targets as putative hits, which can be given a score based on an uncertainty condition. Uncertainties may be due to factors such as uncertainties in detection algorithms (e.g., artificial intelligence or machine learning algorithms), uncertainties in risk level, uncertainties related to potential sensor malfunction, etc.

For example, each detected object or putative hit is assigned a confidence score or set of confidence scores indicative of uncertainty in an object detection. In addition, detected objects can be classified (e.g., by a machine learning classifier) according to object type.

At block 83, the original image and the detection map are input to the image enhancement module 56, or other suitable processing device or processing unit. For each detected object or target, a set of (i.e., one or more) saliency features are applied to the image. As discussed above, a saliency feature is applied to the image by adjusting or manipulating an image attribute, or adding (e.g., overlaying) an attribute.

A saliency feature (or combination of features) is applied to improve the presentation of targets in displays such as external view digital displays. For example, an image region can be selected based on mask instance segmentation, semantic segmentation or other machine learning algorithms.

Any of various types of saliency features may be applied. For example, a saliency feature can be applied to a selected image region by adjusting a color of the selected region, for example, by adjusting the intensity value of one or more color components of pixels in the selected region. In other examples, saliency features can be applied by adjusting the brightness of the object or region, the level of focus, contrast or other attribute(s). An attribute may be adjusted within the selected region (e.g., by brightening the region or alternating an attribute value over time to give a blinking effect), or an attribute may be adjusted in adjacent regions (e.g., by manipulating adjacent regions to increase contrast between the selected region and the adjacent regions). “Contrast” may refer to the difference between a value of an image attribute in one region as compared to another, or refer to image contrast (difference in luminance or color that affects the distinguishability of an object).

In an embodiment, the method 80 includes steps or stages for applying adaptive saliency features, in which the amount or level of adjustment associated with a saliency feature (also referred to as the intensity of the saliency feature) is adjusted based on a user condition.

For example, at block 84, user detection data is acquired using, for example, a Driver Monitoring System (DMS). User detection data relates to any data collected or acquired that is indicative of a condition of the driver. Examples of the condition of a user or driver include user attentiveness (e.g., whether the driver looking at the road or looking at the display, and/or whether the driver looking at a region of the display that includes a target), user emotional state (e.g., whether the driver is agitated or emotional), and others. User detection data may be used to assess driver attentiveness by determining whether the user's attention is directed to a detected object or region of an image in which the object is represented.

In an embodiment, at block 85, the user condition (e.g. attention) is estimated, and a user attentiveness score or value is input to the image enhancement module 56.

User or driver attentiveness relates to an assessment of whether a user's attention is directed toward a detected object, or a region or area in which a detected object is located or expected to be located. In an embodiment, a user is determined to be “attentive” if user data (e.g., from a DMS) indicates that the user is paying attention to a given object or region. Attentiveness may be determined based on eye tracking to determine the direction of the user's gaze. A user may be assessed as attentive or inattentive based on other indications, such as the user's emotional state (determined, e.g., by facial image analysis), and user behavior.

At block 86, the set of saliency features selected at block 83 is adapted or adjusted based on the attentiveness score. For example, in an instance in which a saliency feature includes adjusting the brightness of a region or a target by selecting a brightness value to be applied to pixels in the region or target, if the user's attentiveness score is lower than a threshold, the brightness value can be further increased. Likewise, if the user attentiveness score increases (e.g., the user's gaze is detected to be toward the region), the brightness value can be lowered.

Driver's attentiveness to a detected object may affect the target's visualization. By cross-referencing information from the displayed image and the Driver Monitoring System (DMS), a dynamic score can be generated.

The DMS can generate a loop, where the system guides the driver to observe a specific object.

Once the DMS identifies that the target has been observed, highlighting (e.g., brightness level) of the object may slightly attenuate.

At block 87, the set of saliency features (e.g., directly from block 83 or adapted based on user attentiveness score) is applied to an image, to generate a saliency-based image. The saliency-based image is presented to the user.

It is noted that the set of saliency features can be dynamically changed based on changes in the environment (e.g., changes in the level or amount of external lighting), changes in detected objects, detection of new objects, changes in the user attentiveness and/or other factors. This allows the processing device to dynamically adjust the level of salience of the detected object to the user.

In an embodiment, the set of saliency features are generated by a process that includes selecting a “low level” saliency feature (block 83a), deriving spatial characteristics of each low level saliency feature (block 83b), and if more than one saliency feature is selected, combining or agglomerating the features (block 83c). As discussed further below, a low level saliency feature is a saliency feature that conveys a lower level of salience (importance) than another saliency feature.

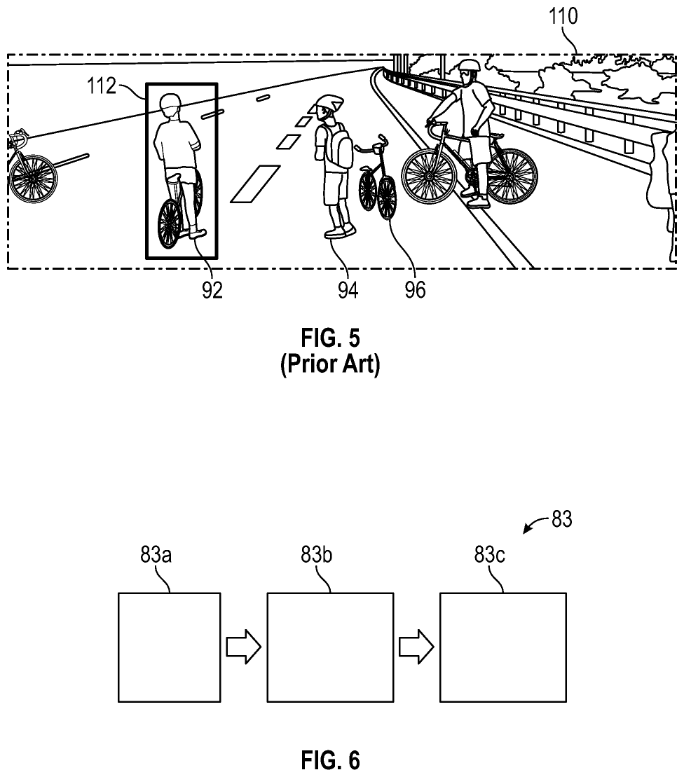

FIG. 4 depicts an example of a saliency-based display 90 including a set of saliency features, which is derived from a camera image acquired from a forward-facing camera of a vehicle, and generated using the method 80. For comparison, FIG. 5 depicts a display 110 based on the same camera image but presented according to a prior art technique.

Both displays present a view of a roadway in front of the vehicle. As shown, there are a number of vulnerable road users, including a bicyclist 92, a bicyclist 94 and a bicycle 96, all of which are located in the roadway ahead of the vehicle. These are detected objects or targets.

As shown in FIG. 4, a saliency feature is applied to each target by increasing the relative brightness of image regions corresponding to each target. The relative brightness can be applied by brightening each region or by darkening areas around the regions. For example, a brightness value is selected for pixels in each region that is higher than the brightness value of the original image. The regions are shown as rectangular, but are not so limited and can have any shape or size. For example, one or more highlighted regions could have shapes that following the contours of a respective target, to make the highlighting less obtrusive.

In this example, a first region 102 surrounds the bicyclist 92, a second region 104 surrounds the bicyclist 94, and a third region 106 surrounds the bicycle 96. As can be seem, the brightened regions serve to highlight the bicyclists 92 and 94, and also surround the bicycle 96, to draw the attention of a user thereto. The brightened regions are highlighted such that the user's attention is drawn without removing any information in the camera image, without attentional capture (e.g., without drawing the user's attention such that other targets are overlooked) and without blocking or occluding any portion of the image.

In contrast to the display of FIG. 4, the prior art display 110 highlights the bicyclist 92 (and/or other targets) using a bounding box 112 that is overlaid on the image. The bounding box 112 is added to the image to draw attention to the bicyclist 92. Although not shown, additional bounding boxes could be added for other targets. However, the bounding box 112 is not subtle and can result in excessive cognitive cost and attentional capture, requiring the user to exert more attention than is warranted, particularly if the targets are putative or uncertain. In addition, the bounding box 112 occludes portions of the image, which could obscure other potential targets or threats. Furthermore, it would be more difficult to divert attention to objects around the bounding box 112, since the attentional capture of the bounding box 112 is so strong. In addition, when multiple targets are identified and multiple bounding boxes are added, this could result in unnecessary clutter.

Advantages of the embodiments described herein include the ability to emphasize targets without necessarily needing to make or display an explicit categorization or perform a dichotomic decision is made for each putative hit or target. In a dichotomic process, a target is either highlighted or not. This can be a problem, for example, if a target is only tentatively identified or there is a level of uncertainty regarding the detection or risk level. Embodiments described herein address this problem by providing the ability to subtly and/or gradually highlight a target in a manner that conveys importance to the user, but does not introduce the cognitive cost (attention level) that a dichotomic process would introduce. In addition, the embodiments, as demonstrated by the above example, avoid the potential for target marking to clutter an image or create visual attentional capture that could compromise the detection of another, competing, target.

FIG. 6 depicts an embodiment of a method of generating a set of one or more saliency features. In this embodiment, the method include steps or stages represented by blocks 83a, 83b and 83c. This method may be part of the method 80, as block 83, or may be a separate method.

At block 83a, a low level saliency feature is selected to be applied to an image region. A low level saliency feature is a saliency feature applied with a selected intensity that is lower than the intensity of saliency features that signify higher importance or urgency.

For example, a low level saliency feature is selected as a color adjustment Mr to pixels in a selected region. The color adjustment may be accomplished by changing the intensity value of one or more color components of pixels in a given color mode. For example, if an image has a red-green-blue (RGB) color mode, the intensity of red green and/or blue color components can be adjusted. Adjustment may be performed for other color modes, such as greyscale and cyan-magenta-yellow-black (CMYK).

In this example, it is determined that red or other single color component adjustment may not be ideal. Instead, a saliency feature can be applied by adjusting a combination of color components. For example, the adjustment Mr is applied to multiple color components, as the difference between the red value and the average of green and blue values, as represented by:

Mr=r−((g+b)/2),

where r represents the intensity (value) of the red component, g represents the intensity of the green component, and b represents the intensity of the blue component.

At block 83b, spatial characteristics of a saliency-enhanced region are determined, and the shape, location and size of the region is selected. The saliency feature or set of saliency features assigned to each pixel in a region is relative to the value of pixels adjacent to the region. Thus, emphasis can be applied to increase saliency by increasing attribute values of pixels in the region and/or by reducing attribute values in adjacent and other pixels outside the region. For example, a highlighted region can be emphasized by increasing brightness in the region and/or by reducing brightness outside of the region, or by reducing the focus (blurring) outside of the region or sharpening/focusing the region.

For example, Mr can be further improved by understanding that Mr values are relative to the values on adjacent pixels. Thus, a pixel can be emphasized by increasing the Mr value at that pixel relative to adjacent pixels, or by reducing the Mr value of adjacent pixels.

At block 83c, the level of saliency of a saliency feature or set of features can be increased by manipulating or adjusting multiple image attributes simultaneously in an image region (or corresponding manipulating the image outside of the region). This can increase the level of salience and also provide a manner to increase the salience gradually or as the environment changes. For example, in addition to manipulating Mr, salience can be increased by simultaneously brightening pixels in the region (or darkening the surrounding image).

The level of salience may be adjusted based on the classification and/or confidence level of a detected object. For example, when an object is detected, a region corresponding to the detected object is selected based on the confidence score, and can be adjusted as the confidence score changes.

The following are examples of low level saliency features and saliency features having higher salience levels. Examples of low level saliency features include applying blue color component adjustment, red color component adjustment, and applying an intensity adjustment.

Examples of mid-level saliency features include blurred areas of an image surrounding a region of a detected object. Mid-level saliency features may be a combination of blurred areas and low level saliency features. High level saliency features can be generated by adding further adjustments or combining several adjustments to achieve a high saliency effect.

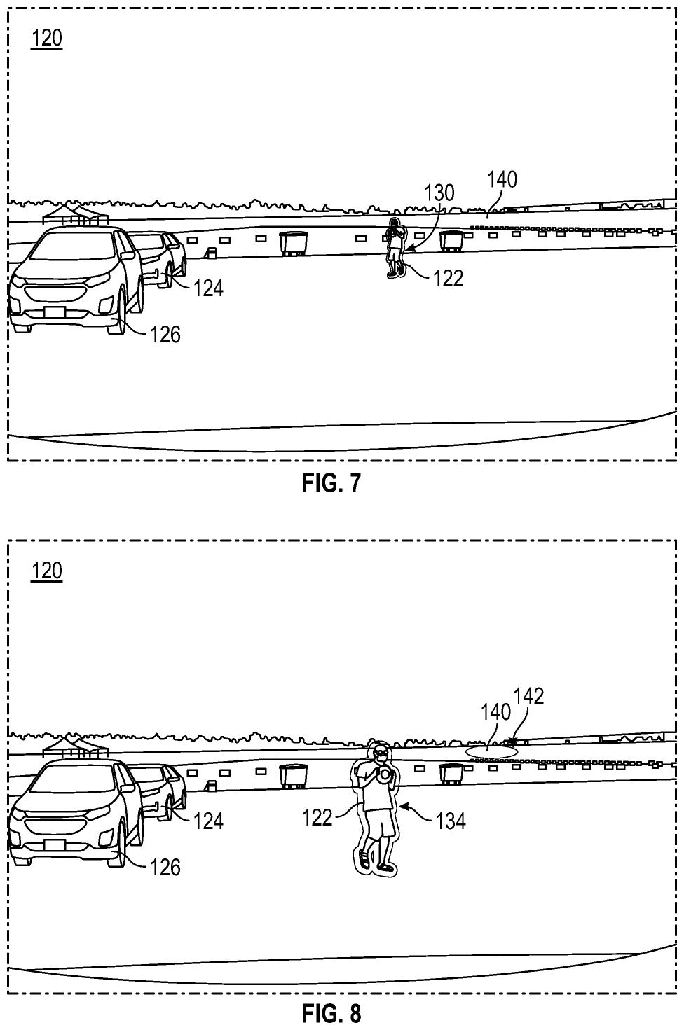

FIGS. 7-9 depict an example of a display 120 presented based on optical camera images taken via a vehicle monitoring system, and illustrates aspects including applying saliency features, dynamically adjusting saliency features and applying combinations of saliency features. In this example, the images are presented successively in real time.

The display 120 depicts an environment in front of a vehicle, which in this example is a parking lot near a recreational facility. As shown, there are a number of objects that could potentially be identified as targets. Such objects include a pedestrian 122 and vehicles 124 and 126.

Referring to FIG. 7, at a first time, the pedestrian 122 is located at a first distance, and a low level saliency feature 130 is applied to a region of the display 120 corresponding to the pedestrian 122. As shown, the saliency feature 130 is applied to a region that surrounds the pedestrian 122 and at least partially follows the contours of the pedestrian 122. The low level saliency feature in this example is applied by brightening the region to a selected brightness level or intensity relative to the surrounding image area.

Referring to FIG. 8, at a second time, the pedestrian 122 is closer to the vehicle, and thereby represents an increase in risk level or importance. A medium level set of saliency features 134 is applied by further increasing the brightness and/or adjusting color components to increase the level of red in the region. This conveys to the user in a subtle manner (and without blocking any portions of the display) to convey an increase in importance. In this example, the red component of pixels in the region is increased in value to apply a red hue to the pedestrian and thereby convey an increase in importance or salience.

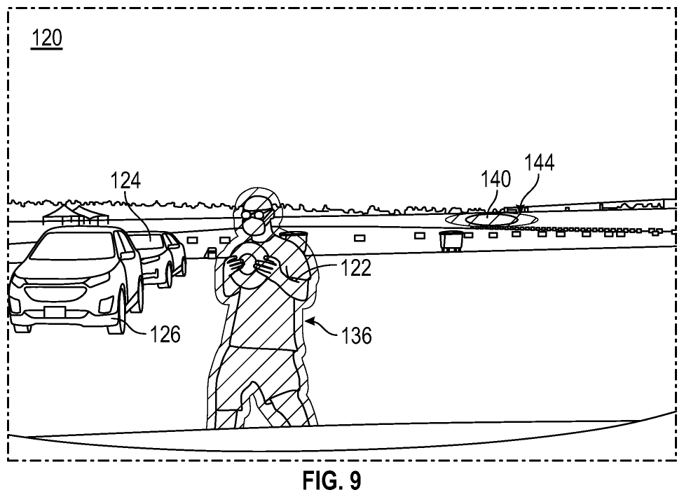

Referring to FIG. 9, at a third time, the pedestrian is even closer, and may therefore represent a higher risk. At this time, a high level set of saliency features 136 is applied by further increasing the level of red to indicate a high level of risk.

Other objects in the display 120 may also be highlighted, similarly to the pedestrian, or by using different levels of salience and or different combinations of saliency features. For example, the vehicles 126 and 124 can be emphasized by brightness (with the same level as the pedestrian or a lower level to signify lower importance). As the pedestrian nears and the salience increases, the regions of the vehicles can be maintained with the same brightness if they remain stationary.

FIGS. 8 and 9 also depict an example of an instance where an object was mistakenly identified as a target. In this instance, a region 140 near the horizon is a strong false alarm. In other words, the vehicle monitoring system detected the region 140 as a target with a high degree of confidence; however, this detection was an error. As shown in FIG. 8, a medium level set of saliency features 142 is applied by increasing the brightness and/or adjusting color components to increase the level of red in the region 140. As shown in FIG. 9, a high level set of saliency features 144 is applied to the region 140 by further increasing the level of red to indicate a high level of risk.

Although the highlighting or emphasis applied to the region 140 was an error, this subtle emphasis does not result in attentional capture, so that the emphasis does not overly distract the user and does not significantly deter from the perception of the main target (the pedestrian 122). In contrast, if bounding boxes or other occluding features were added to the image, there would be a significant amount of attentional capture and potential clutter, as a bounding box at the region 140 would compete for attention. As shown in FIGS. 8 and 9, using saliency features as described herein reduces the amount of attentional capture as compared to bounding boxes and other highlighting techniques. In addition, as the saliency features do not occlude any part of the region 140, it is relatively easy for the user to see the content of the region 140 and determine that the region does not constitute any threat or risk.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A system for notifying a user of a vehicle, comprising:
a receiving module configured to receive detection data from one or more sensors, the detection data related to an environment around the vehicle, the detection data including an image of at least a portion of the environment;
an analysis module configured to detect an object in the image and determine a level of salience of the detected object to the user;
an image enhancement module configured to apply one or more saliency features to a region of the image corresponding to the detected object, the one or more saliency features including an adjustment to an image attribute in the region, the adjustment based on the level of salience and configured to draw attention of the user to the region without occluding the region; and
a display module configured to present a display including the image and the one or more saliency features to the user.

2. The system of claim 1, wherein the image is an optical image taken by a camera, and the display is a digital display in the vehicle.

3. The system of claim 1, wherein the image attribute is selected from at least one of color, brightness, focus level and contrast.

4. The system of claim 1, wherein the level of salience is based on at least one of: an uncertainty in detection of the detected object, an attentiveness of the user to the detected object, a classification of the detected object, and a risk value associated with the detected object.

5. The system of claim 1, wherein an intensity of the adjustment is selected based on the level of salience.

6. The system of claim 1, wherein the one or more saliency features includes a combination of a plurality of saliency features.

7. The system of claim 5, wherein the intensity corresponds to a selected value of the attribute relative to a value of the attribute in the image outside of the region.

8. The system of claim 5, wherein at least one of the intensity of the adjustment and a number of saliency features applied to the region is gradually changed in the display as the level of salience changes.

9. A method of notifying a user of a vehicle, comprising:
receiving detection data from one or more sensors, the detection data related to an environment around the vehicle, the detection data including an image of at least a portion of the environment;
detecting, by an analysis module, an object in the image and determining a level of salience of the detected object to the user;
applying, by an image enhancement module, one or more saliency features to a region of the image corresponding to the detected object, the one or more saliency features including an adjustment to an image attribute in the region, the adjustment based on the level of salience and configured to draw attention of the user to the region without occluding the region; and
presenting a display including the image and the one or more saliency features to the user.

10. The method of claim 9, wherein the image is an optical image taken by a camera, and the display is a digital display in the vehicle.

11. The method of claim 9, wherein the image attribute is selected from at least one of color, brightness, focus level and contrast.

12. The method of claim 9, wherein the level of salience is based on at least one of: an uncertainty in detection of the detected object, an attentiveness of the user to the detected object, a classification of the detected object, and a risk value associated with the detected object.

13. The method of claim 9, wherein an intensity of the adjustment is selected based on the level of salience.

14. The method of claim 9, wherein the one or more saliency features includes a combination of a plurality of saliency features.

15. The method of claim 13, wherein the intensity corresponds to a selected value of the attribute relative to a value of the attribute in the image outside of the region.

16. The method of claim 13, wherein at least one of the intensity of the adjustment and a number of saliency features applied to the region is gradually changed in the display as the level of salience changes.

17. A vehicle system comprising:
a memory having computer readable instructions; and
a processing device for executing the computer readable instructions, the computer readable instructions controlling the processing device to perform:
receiving detection data from one or more sensors, the detection data related to an environment around the vehicle, the detection data including an image of at least a portion of the environment;
detecting, by an analysis module, an object in the image and determining a level of salience of the detected object to a user;
applying, by an image enhancement module, one or more saliency features to a region of the image corresponding to the detected object, the one or more saliency features including an adjustment to an image attribute in the region, the adjustment based on the level of salience and configured to draw attention of the user to the region without occluding the region; and
presenting a display including the image and the one or more saliency features to the user.

18. The vehicle system of claim 17, wherein the level of salience is based on at least one of: an uncertainty in detection of the detected object, an attentiveness of the user to the detected object, a classification of the detected object, and a risk value associated with the detected object.

19. The vehicle system of claim 17, wherein an intensity of the adjustment is selected based on the level of salience, and the intensity corresponds to a selected value of the attribute relative to a value of the attribute in the image outside of the region.

20. The vehicle system of claim 17, wherein the one or more saliency features includes a combination of a plurality of saliency features.
